(19) United States
(12) Patent Application Publication
(10) Pub. No.: US 2011/0299049 A1
(43) Pub. Date: Dec. 8, 2011

(54) PROJECTION TYPE DISPLAY APPARATUS

(75) Inventors: Masahiko YATSU, Fujisawa (JP); Koji Hirata, Yokohama (JP)

(73) Assignee: Hitachi Consumer Electronics Co., Ltd.

(21) Appl. No.: 13/090,458

(22) Filed: Apr. 20, 2011

(30) Foreign Application Priority Data
Jun. 2, 2010 (JP) 2010-126438

(51) Int. Cl. G03B 21/28

(52) U.S. Cl. 353/98

(57) ABSTRACT

A projection type display apparatus includes: a lens group comprising a plurality of lenses arranged in the traveling direction of light with respect to an image display element; a first lens arranged in the traveling direction of light with respect to the lens group; a second lens arranged in the traveling direction of light with respect to the first lens; and a mirror for reflecting light emitted from the second lens and obliquely projecting the reflected light onto a screen, wherein a lens, among the lens group, nearest to the first lens is a meniscus lens with its convex surface facing the direction of the first lens, wherein the first lens is a meniscus lens with its convex surface facing the direction of the second lens, and wherein the second lens is a meniscus lens with its convex surface facing the direction of the mirror.

### INCORPORATION BY REFERENCE

The present application claims priority from Japanese application JP 2010-126438 filed on Jun. 2, 2010, the content of which is hereby incorporated by reference into this application.

### BACKGROUND OF THE INVENTION

The present invention relates to a projection type display apparatuses.

In the conventional art, a projection optical system 30 (FIG. 9) using two free-form curved lenses and one free-form curved mirror is known (see JP-A-2009-109867).

FIG. 10 is a light beam diagram illustrating light beams from an object surface (image display element surface) to an image surface in the projection optical system 30 of FIG. 9. FIG. 11, (A) is a light beam diagram in a YZ cross section which focuses on the light beams before and after reflection at the free-form curved mirror, and FIG. 11, (B) is a light beam diagram in a XZ cross section of the optical path to the free-form curved mirror 13. FIG. 12 is an explanatory view of object point (image point) arrangement which is a basis for ray trace. In FIG. 12, a total of ten object points is provided, each representing the light beam from each object point.

### SUMMARY OF THE INVENTION

According to the conventional art (FIG. 9), a projection optical system using free-form curved lenses 21, 22 and a free-form curved mirror 23 can obtain a large projected image with a short projection distance (the distance from the object surface (image display element surface) to the optical axis of the free-form curved mirror 23 is 327.6 mm, the distance from the optical axis of the free-form curved mirror 23 to the image surface is 567 mm, thus realizing an 80-inch image). However, there is a need to achieve a further reduction in the projection distance and a further reduction in the size of the projection optical system.

Then, it is an object of the present invention to provide a projection type display apparatus achieving a further reduction in the projection distance (a wider angle of view) and a further reduction in the size of the projection optical system.

In order to solve the above-described problems, according to one of the preferable aspects of the present invention, a projection type display apparatus comprises: a lens group comprising a plurality of lenses arranged in a traveling direction of light with respect to an image display element; a first lens arranged in the traveling direction of light with respect to the lens group; a second lens arranged in the traveling direction of light with respect to the first lens; and a mirror for reflecting light emitted from the second lens and obliquely projecting the reflected light onto a screen, wherein the lens, among the lens group, closest to the first lens is a meniscus lens with its convex surface facing the direction of the first lens, wherein the first lens is a meniscus lens with its convex surface facing the direction of the second lens, and wherein the second lens is a meniscus lens with its convex surface facing the direction of the mirror.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a projection optical system according to an embodiment.

FIG. 2 is a light beam diagram of the projection optical system according to the embodiment.

FIG. 3, (A) and (B) are light beam diagrams of an essential portion representing the reflection light paths formed by a free-form curved mirror according to the embodiment.

FIG. 4 is a list of lens data, such as curvature radius and inter-surface distance, according to the embodiment.

FIG. 5 represents an equation for free-form curved surfaces and coefficients of the free-form curved surfaces according to the embodiment.

FIG. 6, (A) and (B) represent a definitional equation and coefficients of aspherical surfaces and odd-order polynomial aspherical surfaces.

FIG. 7 is a spot diagram according to the embodiment.

FIG. 8 is a distortion performance chart according to the embodiment.

FIG. 9 is a block diagram of a projection optical system of a conventional example.

FIG. 10 is a light beam diagram of the projection optical system of the conventional example.

FIG. 11, (A) and (B) represent beam diagrams of an essential portion representing reflection light paths formed by a free-form curved mirror in the conventional example.

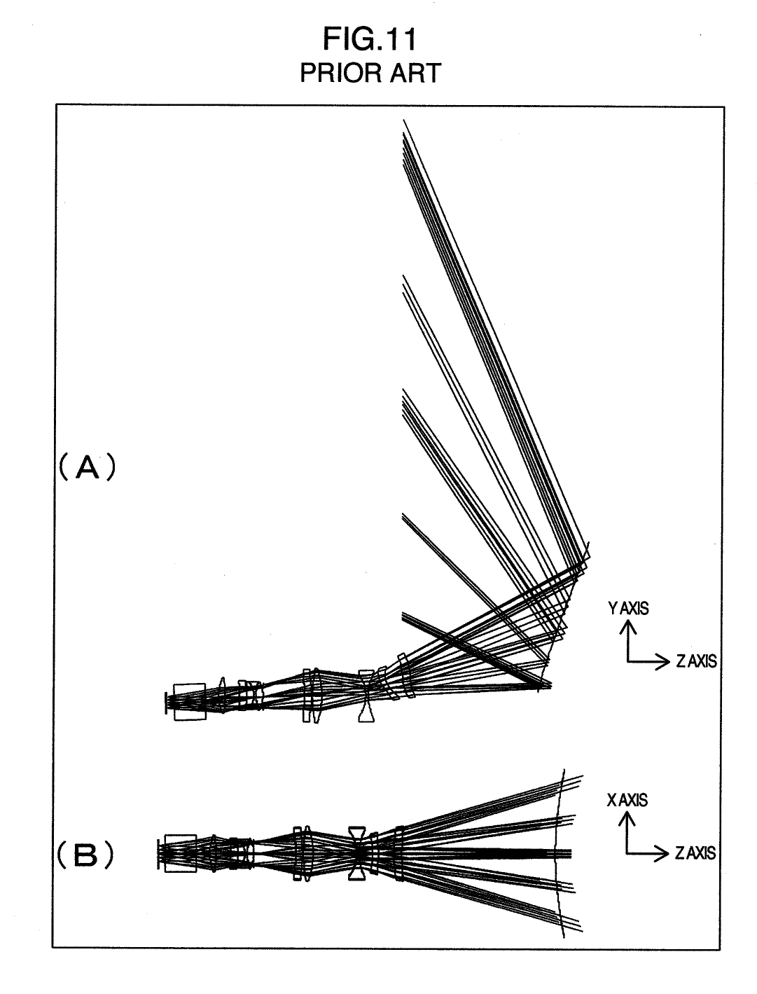

FIG. 12 is an explanatory view of object point (image point) arrangement which is a basis for ray trace.

### DETAILED DESCRIPTION OF THE EMBODIMENTS

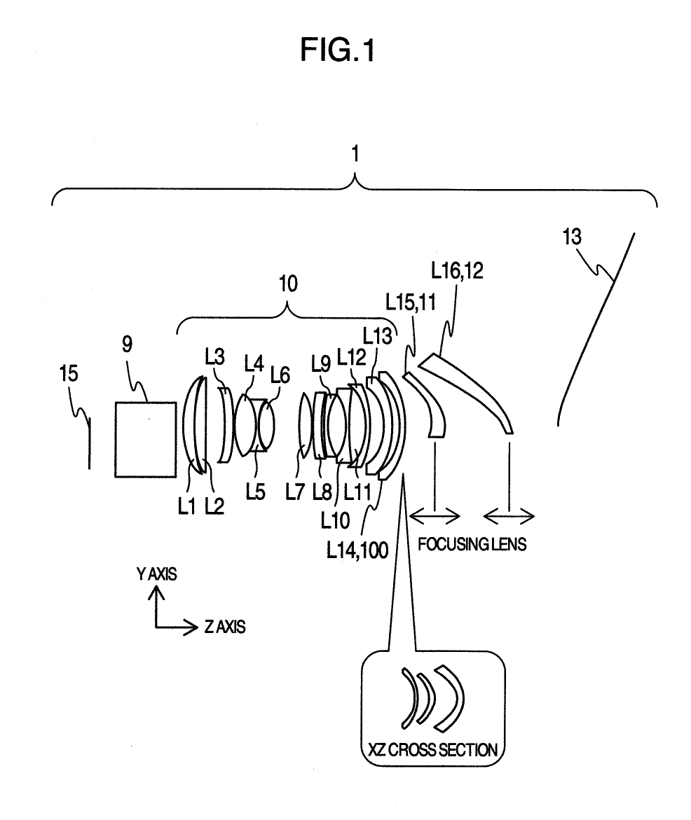

Hereinafter, an embodiment will be described with reference to the accompanying drawings of FIG. 1 to FIG. 8.

FIG. 1 is a block diagram of a projection optical system 1. In the projection optical system 1, in the traveling direction of light, an image display element 15, a conversion filter 9, a coaxial lens group 10 having a refraction function and comprising a plurality of lenses, a first free-form curved lens 11 having a positive refractive power, a second free-form curved lens 12 having a negative refractive power, and a free-form curved mirror 13 are arranged in this order. Note that the free-form curved surface refers to a rotationally asymmetric curved surface, for example.

Here, the refractive power of the free-form curved lens is defined as a positive refractive power when a travel distance that a principal ray far from the optical axis of the lens group 10 passes through a relevant free-form curved lens is shorter than a travel distance that a principal ray close to the optical axis of the lens group 10 passes through the relevant free-form curved lens. In contrast, the refractive power of a free-form curved lens is defined as a negative refractive power when a travel distance that the principal ray far from the optical axis of the lens group 10 passes through the relevant free-form curved lens is longer than the travel distance that the principal ray close to the optical axis of the lens group 10 passes through the relevant free-form curved lens. Note that, when the light beam travels in the lens optical axis, the travel distance becomes equal to the center thickness of the lens. Among the lens group 10, a lens 100 arranged closest to the first free-form curved lens 11, the first free-form curved lens 11 and the second free-form curved lens 12 each have meniscus lens shape with their convex surfaces facing the traveling direction of light.

The first free-form curved lens 11 has a positive refractive power because the lens has thicknesses, both in the YZ cross section and in the XZ cross section, thinner in its portion far from the optical axis than in its portion near the optical axis side.

The second free-form curved lens 12 has a negative refractive power because its lens has thicknesses, both in the YZ cross section and in the XZ cross section, thicker in its portion far from the optical axis than in its portion near the optical axis side.

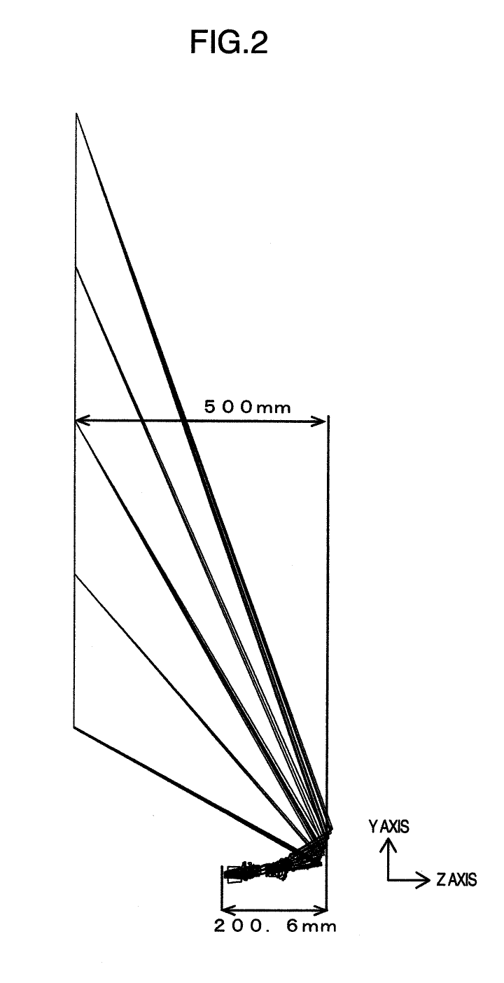

FIG. 2 is a light beam diagram of the projection optical system 1.

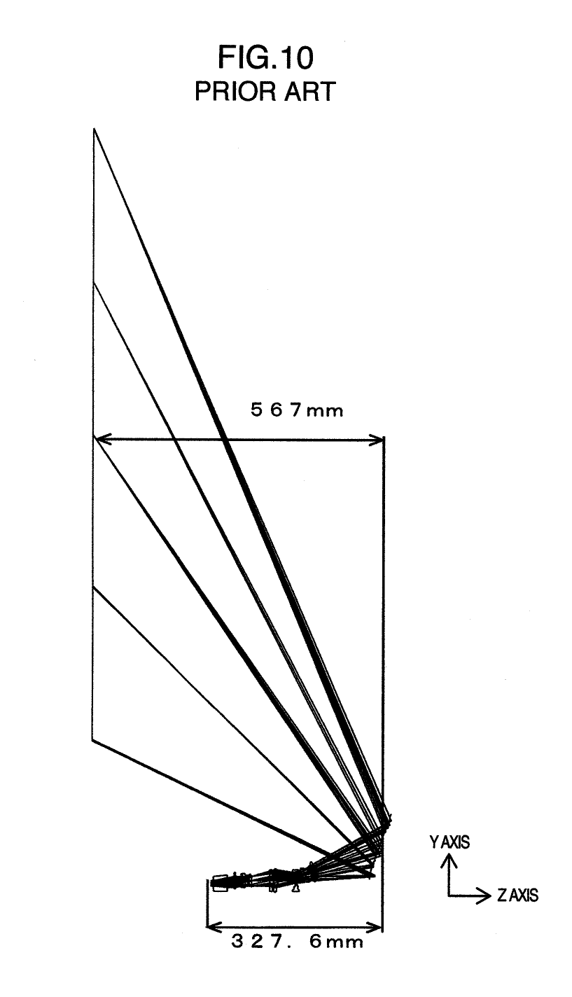

In the projection optical system 1, the distance from the optical axis of the free-form curved mirror 13 to the image surface is 500 mm, and the distance from the object surface (image display element surface) to the optical axis of the free-form curved mirror 13 is 200.6 mm, thus realizing an 80 inch image. That is, this embodiment has achieved a reduction in the projection distance and a reduction in the size of the projection optical system 1 as compared with the projection optical system of conventional art illustrated in FIG. 10.

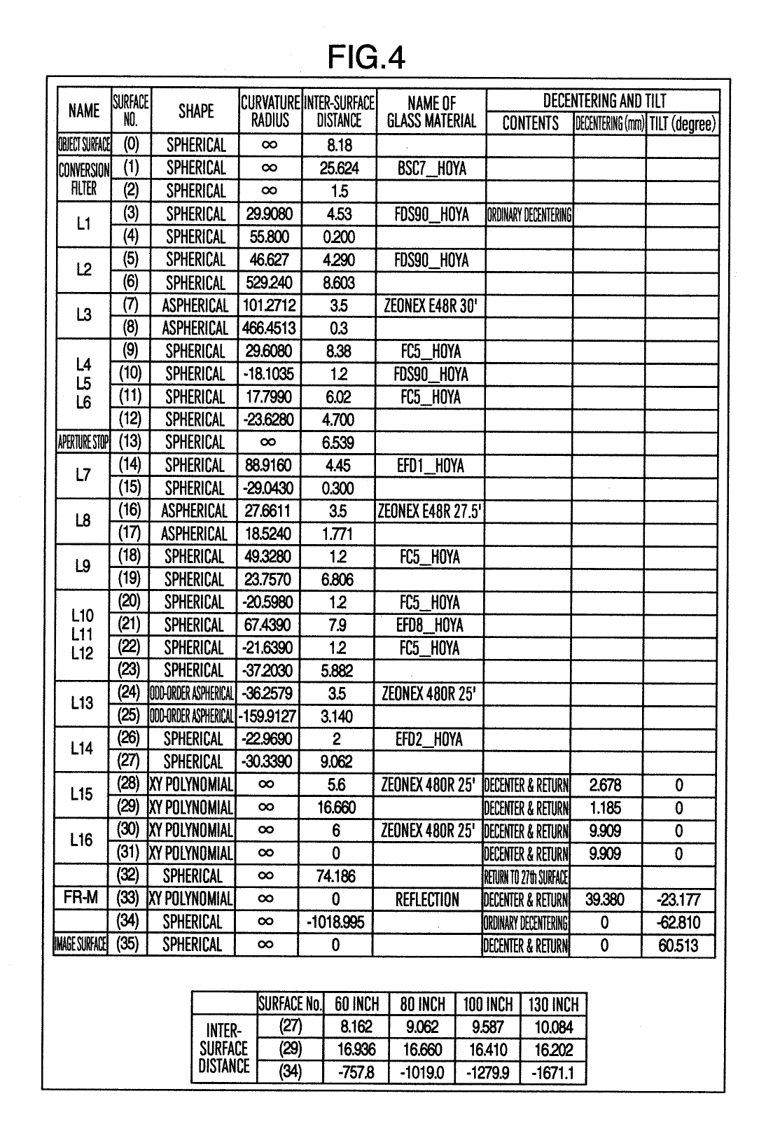

Note that, in this embodiment, the optical axis of the free-form curved mirror 13 resides at a place on the optical-axis of the lens group 10 and 74.186 mm ahead from the 27th surface in FIG. 4 and going up by 39.38 mm on the Y-axis, however, it is needless to say that the position may vary depending on how to take lens data.

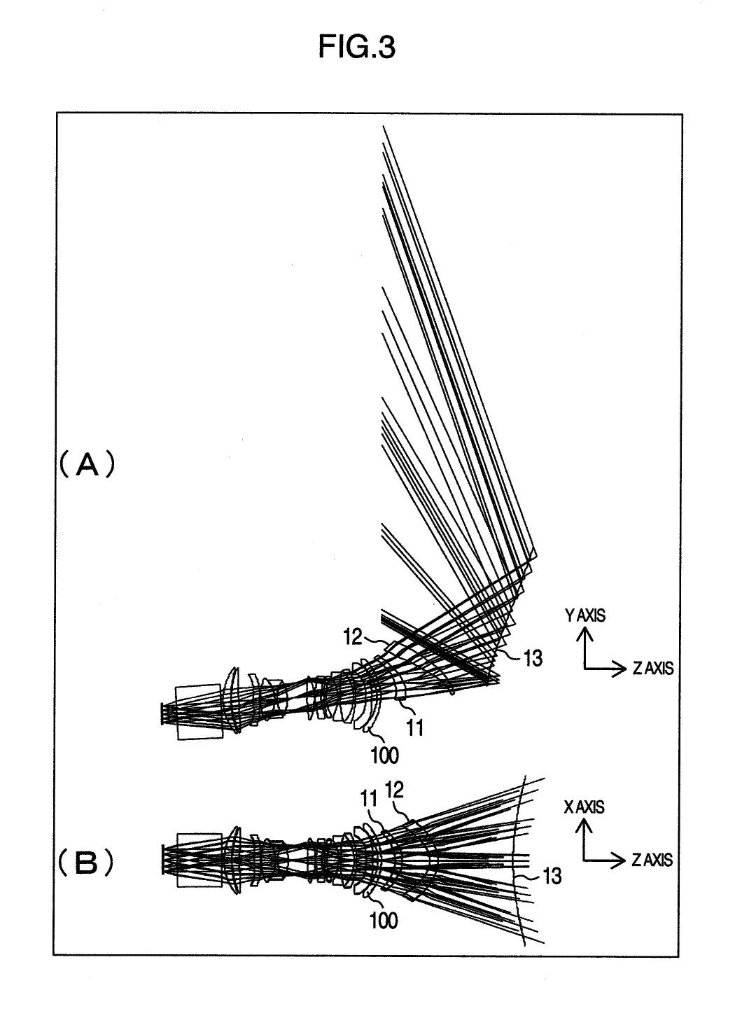

FIG. 3, (A) and (B) illustrate a light beam diagram of an essential portion representing the reflection light paths formed by the free-form curved mirror 13. In a substantially triangular space between the lens 100 and the light beam reflected by the free-form curved mirror 13, the first free-form curved lens 11 and the second free-form curved lens 12 are arranged.

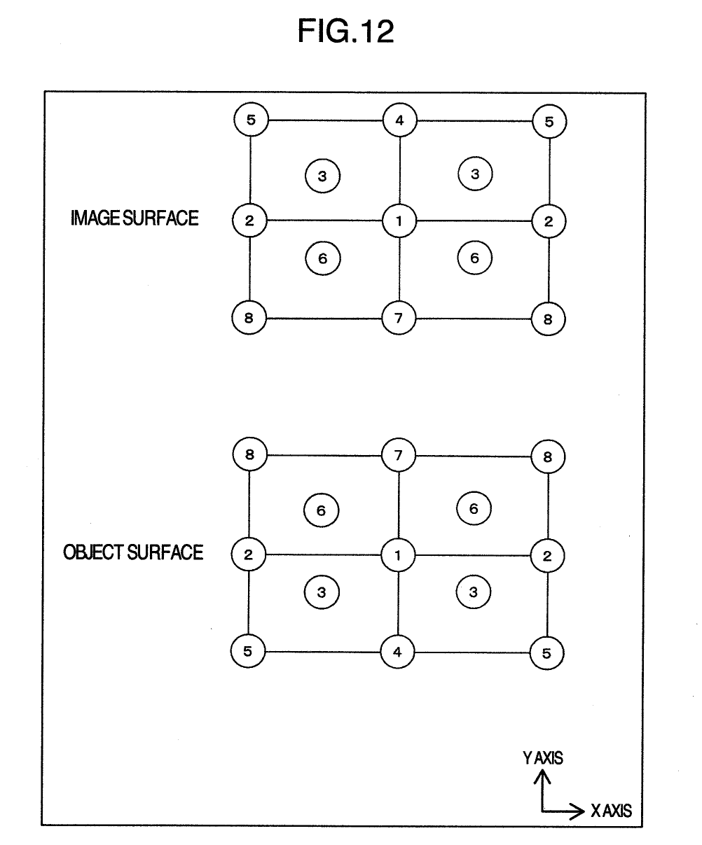

In the projection optical system 1, the optical path is folded back by the free-form curved mirror 13. Therefore, if a light beam reflected by the free-form curved mirror 13 is radiated to the projection optical system 1 itself (e.g., the free-form curved lens 12), a shadow is generated in the image, thus posing a problem. However, this problem can be circumvented because the light beams reflected by the free-form curved mirror 13 pass considerably above the second free-form curved lens 12 in order to keep away from an edge portion of the second free-form curved lens 12 extending upwards. Note that the object point where the light beam reflected by the free-form curved mirror 13 passes through a portion closest to the second free-form curved lens 12 is the object point (7) of FIG. 12.

Here, in FIG. 3, (A) and (B), a light beam passing through a position closest to the second free-form curved lens 12, among the light beams reflected by the free-form curved mirror 13, and the output surface of the second free-form curved lens 12 are substantially parallel to each other.

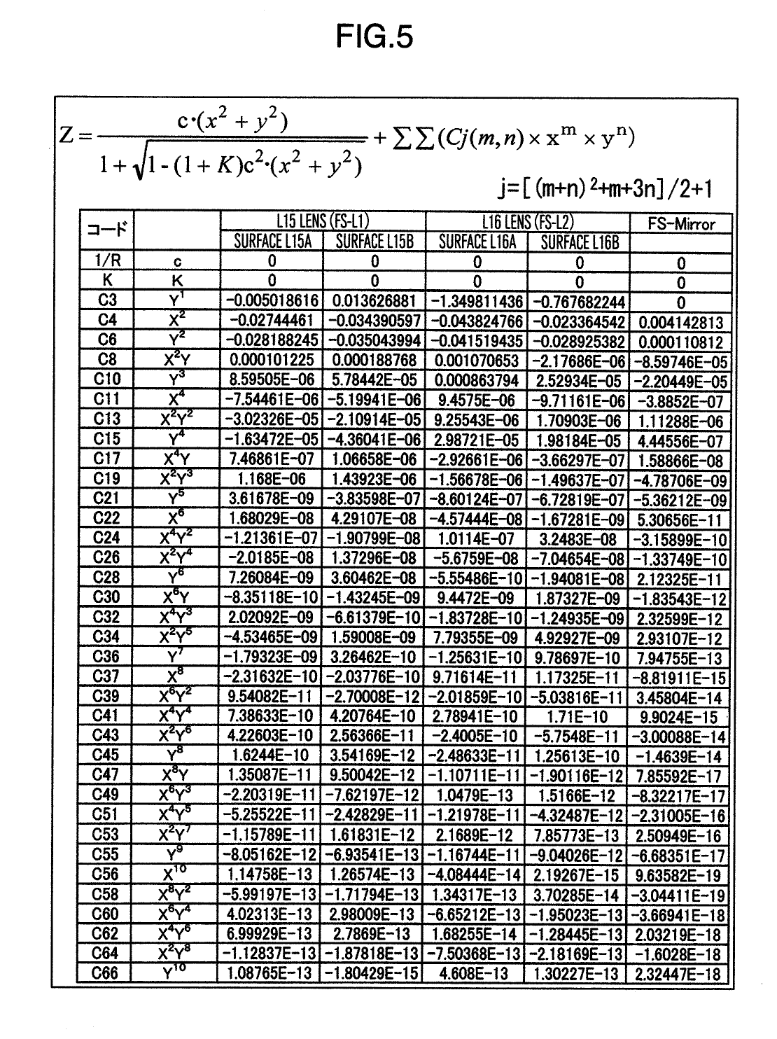

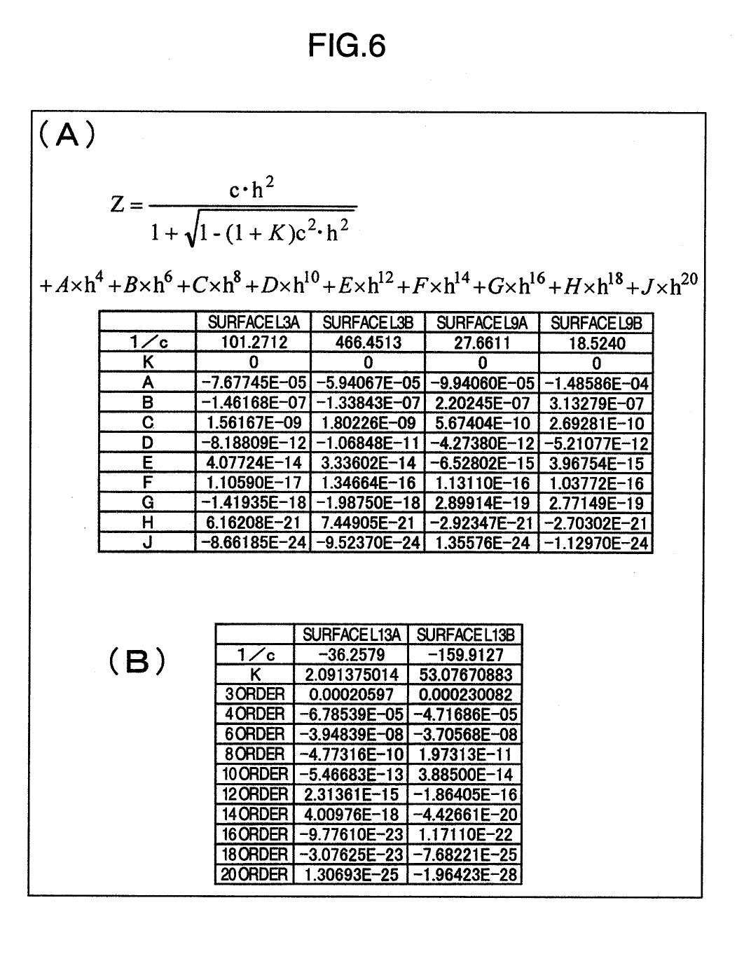

Moreover, the shape of an air lens formed in the space between the first free-form curved lens 11 and the second free-form curved lens 12 is a meniscus lens shape with its convex surface facing the direction of the free-form curved mirror. With regard to the details of the lens surfaces in FIG. 1, FIG. 4 represents curvature radius, inter-surface distance, the name of glass material, and the like, FIG. 5 represents a definitional equation and coefficients of the free-form curved surface, and FIG. 6, (A) and (B) represent a definitional equation and coefficients of an aspherical surface and an odd-order polynomial aspherical surface. Note that, the surface number 0 refers to the object surface (image display element surface), the surface number 35 refers to the image surface, and the surface numbers 1 to 34 refer to the lens surface, mirror surface, and the like.

The curvature radius is defined as positive when its center of curvature is located on the right side. The inter-surface distance is the distance on the optical axis of each lens surface, and is defined in the state before each lens surface is decentered and tilted.

As for the decentering and tilt of each surface, the decentering acts first followed by the tilt. With regard to the tilt, the order of acting on three coordinate axes is predetermined, however, this lens data includes only the rotation around the X axis (horizontal coordinate axis perpendicular to the optical axis), and the clockwise rotation when viewed from the positive direction of the X axis is defined as positive. Note that the decentering and tilt defined by decenter & return act only on its lens surface.

In addition, the shapes of the first free-form curved lens 11, second free-form curved lens 12, and free-form curved mirror 13 are expressed with polynomials of X and Y (XY polynomial surface).

The aspherical surface shape is a rotationally symmetric shape using only even-order coefficients from the 4th order to 20th order of the distance h from the optical axis, and the odd-order polynomial aspherical surface is expressed with a rotationally symmetric shape using odd-order and even-order coefficients of the distance h from the optical axis.

The projection optical system of this embodiment is an ultra wide angle projection optical system with F1.8 and a short focal length of 4.1 mm. Note that the focal length can be calculated by substituting the magnification and projection distance between the object (image display element) and the image into the equation of image formation.

The travel distances of the principal ray of each field angle in the respective free-form curved lenses when the principal ray of each field angle passes through the respective free-form curved lenses are represented in Table 1. It is recognized that the first free-form curved lens has a positive refractive power and the second free-form curved lens has a negative refractive power.

TABLE 1

| | First | Second | Object point closest to a base, |
|---|---|---|---|
| Object | free-form | free-form | among the bilaterally-symmetric |
| point | curved lens | curved lens | object points of FIG. 12 |
| (1) | 3.8 mm | 6.2 mm | |
| (2) | 3.1 mm | 7.1 mm | |
| (3) | 3.0 mm | 7.4 mm | |
| (4) | 2.7 mm | 7.7 mm | Object point far from the optical |
| | | | axis of coaxial lens system in |
| | | | the YZ cross-section |
| (5) | 2.9 mm | 7.6 mm | |
| (6) | 4.4 mm | 5.3 mm | |
| (7) | 5.5 mm | 2.6 mm | Object point close to the optical |
| | | | axis of coaxial lens system |
| (8) | 3.9 mm | 6.0 mm | Object point far from the optical |
| | | | axis of coaxial lens system in |
| | | | the XZ cross section |

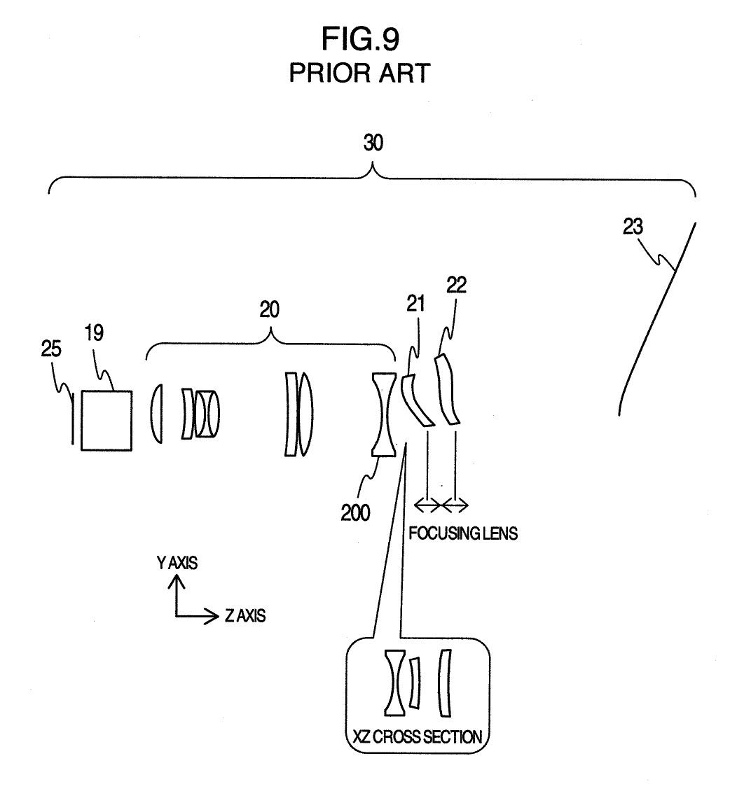

On the other hand, for comparison, the travel distances of the principal ray in the respective free-form curved lenses when the principal ray passes through the respective free-form curved lenses, in the conventional projection optical system of FIG. 9, are represented in Table 2. It is recognized that in the conventional projection optical system the first free-form curved lens has a negative refractive power and the second free-form curved lens has a negative refractive power.

TABLE 2

| | First | Second | Object point closest to a basis, |
|---|---|---|---|
| Object | free-form | free-form | among the bilaterally-symmetric |
| point | curved lens | curved lens | object points of FIG. 12 |
| (1) | 4.8 mm | 6.5 mm | |
| (2) | 5.3 mm | 6.7 mm | |
| (3) | 5.3 mm | 6.9 mm | |
| (4) | 5.9 mm | 6.8 mm | Object point far from the optical |
| | | | axis of coaxial lens system in |
| | | | the YZ cross section |
| (5) | 6.5 mm | 6.3 mm | |
| (6) | 4.8 mm | 6.1 mm | |
| (7) | 4.8 mm | 5.7 mm | Object point close to the optical |
| | | | axis of coaxial lens system |
| (8) | 5.3 mm | 6.1 mm | Object point far from the optical |
| | | | axis of coaxial lens system in |
| | | | the XZ cross section |

As described above, the projection optical system of this embodiment has a size smaller than the conventional projection optical system while having a projection distance shorter than the conventional projection optical system.

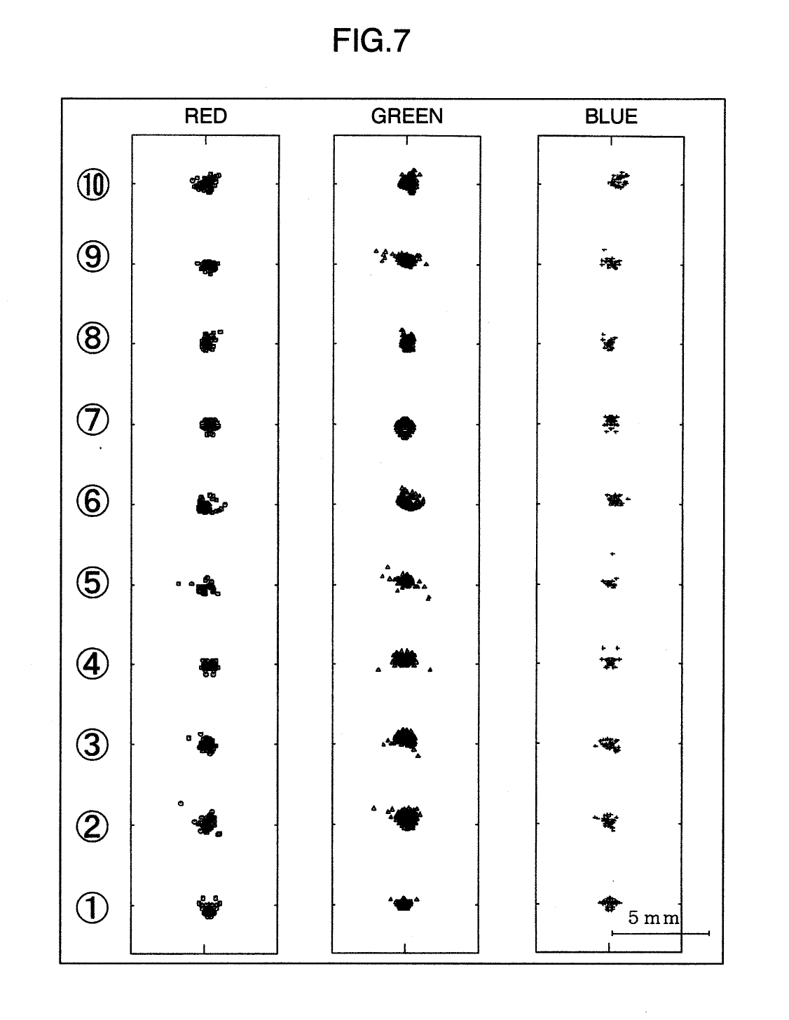

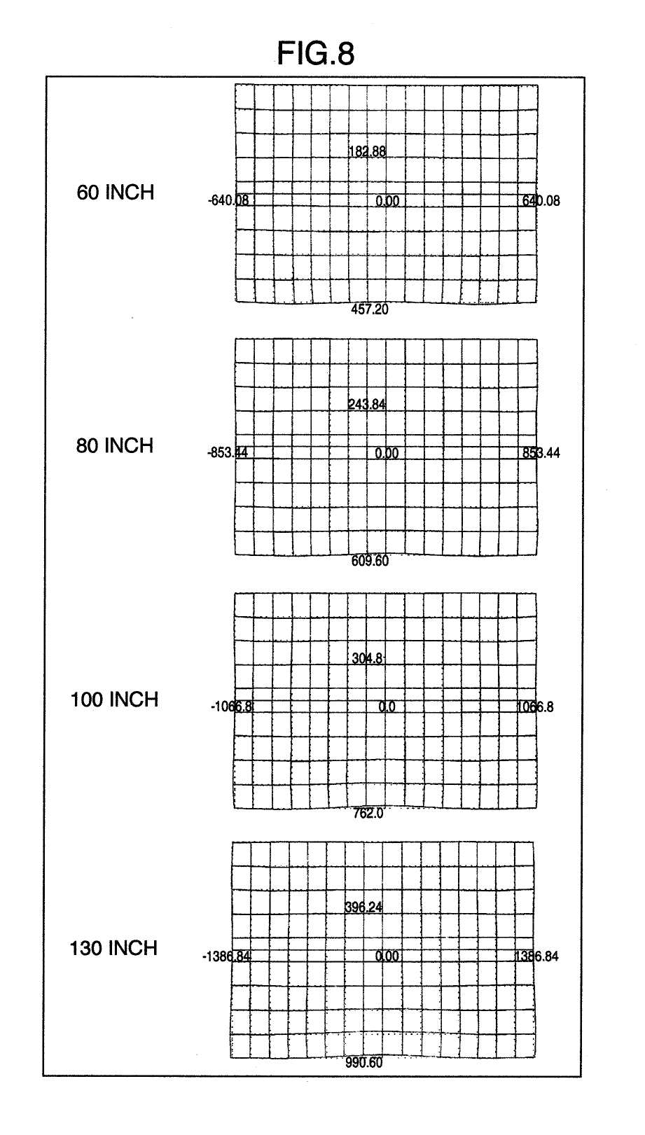

Finally, FIG. 7 is a spot diagram of each object point (FIG. 12) for red, green and blue at a distance where a 0.63-inch panel produces an 80-inch image (FIG. 2). FIG. 8 is a distortion performance chart at projection distances where the 0.63-inch panel produces a 60-inch image, an 80-inch image, a 100-inch image, and a 130-inch image. In this distortion performance chart, the distortion amount is emphasized and shown by being increased tenfold. As apparent from these data, the above-described projection optical system has excellent optical performances.

Note that, this embodiment has been described using the first free-form curved lens 11, the second free-form curved lens 12, and the free-form curved mirror 13, but not limited to the free-form curved surface, and for example, the aspheric surface lens or mirror instead of the free-form curved surface may be used. However, if the projection optical system is arranged diagonally with respect to the screen, a rotationally asymmetric error generates (trapezoidal distortion generates or the focusing position varies with location). In order to correct this error, it is more effective to use free-form curved surfaces, in particular rotationally asymmetric optical elements (a lens, a mirror, and the like).

It should be further understood by those skilled in the art that although the foregoing description has been made on embodiments of the invention, the invention is not limited thereto and various changes and modifications may be made without departing from the spirit of the invention and the scope of the appended claims.

The present invention can provide a projection type display apparatus achieving a further reduction in the projection distance (wider angle of view) and a further reduction in the size of the projection optical system.

1. A projection type display apparatus, comprising:
a lens group comprising a plurality of lenses arranged in a traveling direction of light with respect to an image display element;
a first lens arranged in a traveling direction of light with respect to the lens group and having a free-form curved shape;
a second lens arranged in a traveling direction of light with respect to the lens group and having a free-form curved shape;
a mirror for reflecting light emitted from the second lens and obliquely projecting the reflected light onto a screen, the mirror having a free-form curved shape;
wherein a lens closest to the first lens among the lens group is a meniscus lens whose convex surface facing a direction of the first lens;
wherein the first lens is a meniscus lens whose convex surface facing a direction of the second lens; and
wherein the second lens is a meniscus lens whose convex surface facing a direction of the mirror.

2. The projection type display apparatus according to claim 1, wherein a refractive power of a lens closest to the first lens among the lens group is negative, a refractive power of the first lens is positive, and a refractive power of the second lens is negative.

3. The projection type display apparatus according to claim 1, wherein, among the light beams reflected by the mirror, a light beam passing through a position closest to the second lens and an output surface of the second lens are substantially parallel to each other.

4. The projection type display apparatus according to claim 2, wherein, among the light beams reflected by the mirror, a light beam passing through a position closest to the second lens and an output surface of the second lens are substantially parallel to each other.

5. The projection type display apparatus according to claim 1, wherein a shape of an air lens formed in a space between the first lens and the second lens is a meniscus lens shape whose convex surface facing a direction of the mirror.

6. The projection type display apparatus according to claim 2, wherein a shape of an air lens formed in a space between the first lens and the second lens is a meniscus lens shape whose convex surface facing a direction of the mirror.

7. The projection type display apparatus according to claim 3, wherein a shape of an air lens formed in a space between the first lens and the second lens is a meniscus lens shape with its convex surface facing a direction of the mirror.

8. The projection type display apparatus according to claim 4, wherein a shape of an air lens formed in a space between the first lens and the second lens is a meniscus lens shape with its convex surface facing a direction of the mirror.
